(19) United States
(12) Patent Application Publication
(10) Pub. No.: US 2006/0065882 A1
(43) Pub. Date: Mar. 30, 2006

(54) CONCRETE FORM REMOVAL TOOL

(76) Inventor: NORMAN PICARD, Sherwood Park (CA)

Correspondence Address: STEPHEN J. LEWELLYN, 933 OLEANDER WAY SOUTH, SUITE 3, SOUTH PASADENA, FL, 33707, US

(21) Appl. No.: 10/711,722

(22) Filed: Sep. 30, 2004

(51) Int. Cl. B66F 3/00

(52) U.S. Cl. 254/131

(57) ABSTRACT

A concrete form removal tool is provided. The tool is used for efficient removal of a concrete form from a concrete structure that has sufficiently cured with out the tool contacting the structure. The tool includes an elongated handle, and a form engagement member affixed to and extending transversely from the handle. The form engagement member has a hooked end that is adapted to engage the form in a manner such that the handle is initially positioned parallel to the concrete structure from which the form is to be removed from, and such that the when the handle is pulled upon in a direction away from the structure the form is removed therefrom.

### FIELD OF THE INVENTION

The present invention relates generally to removing concrete forms from concrete structures. More particularly, relating to a hand held tool for removing concrete forms from a concrete structure once the concrete has cured sufficiently.

### SUMMARY OF THE PRIOR ART

Numerous tools and apparatuses exist for facilitating the removal of a concrete form from a concrete structure once the structure as properly cured. The following patents discuss various examples of such devices: U.S. Pat. Nos. 1,907,048; 4,102,527; and 6,752,382.

However, there exists a need for a new and improved concrete form removal tool which is easily manipulable by a single user, in expensive to manufacture, is of simple construction and does not contact the structure from which the form is sought to be removed from. As such, the instant invention seeks to fulfill these voids now current in the prior art.

### SUMMARY OF THE INVENTION

In accordance with the present invention, an apparatus for removing a concrete form from a concrete structure without damaging the structure or using the structure as a pry surface is provided. The concrete form removal tool includes an elongated handle, and a form engagement member affixed to the handle and extending transversely from the handle. The form engagement member has a hooked end that is adapted to engage the form in a manner such that the handle is initially positioned parallel to the concrete structure from which the form is to be removed from, and such that the when the handle is pulled upon in a direction away from the structure the form is removed therefrom.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood when consideration is given to the following detailed description thereof. Such description makes reference to the annexed drawings wherein:

FIG. 1 is a perspective in-use view of the preferred embodiment of the concrete form removal tool constructed in accordance with the principles of the present invention;

FIG. 2 is a top perspective view of the concrete form removal tool;

FIG. 3 is a bottom perspective view of the concrete form removal tool;

FIG. 4a is a top plan view of the concrete form removal tool engaged with a concrete form and in a initial position;

FIG. 4b is a top plan view of the concrete form removal tool engaged with a concrete form and in a pulled position; and

FIG. 5 is a cross sectional view taken along line 5-5 in FIG. 4a.

The same reference numerals refer to the same parts throughout the various figures.

### DETAILED DESCRIPTION OF THE INVENTION

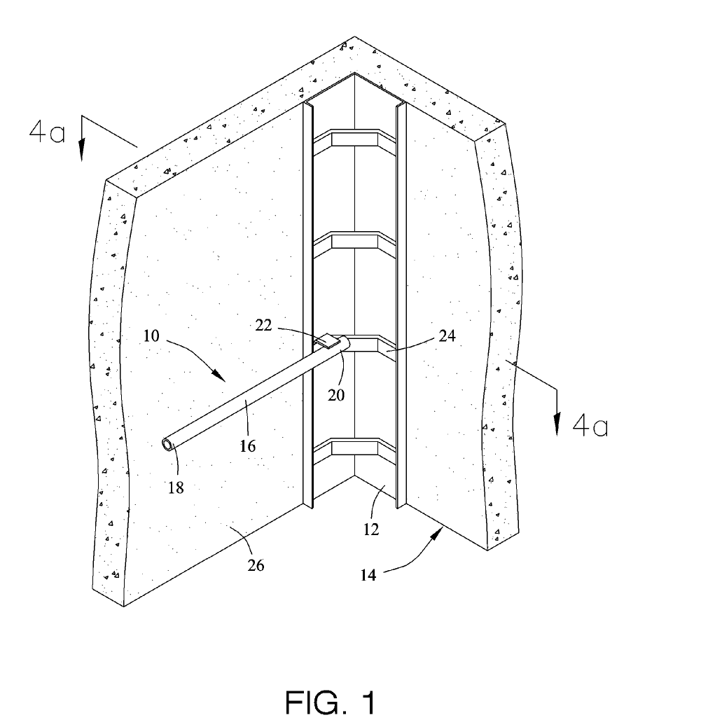

Referring now to the drawings, and particularly to FIGS. 1-5, a preferred embodiment of the concrete form removal tool of the present invention is shown and generally designated by the reference numeral 10.

In FIG. 1, a new and improved concrete form removal tool 10 of the present invention for pulling a concrete form 12 from a concrete structure 14 is illustrated and will be described. More particularly, the concrete form removal tool includes a handle 16 having a first end 18 and a second end 20, and a form engagement member 22 affixed to the handle.

The form engagement member 22 is affixed to the handle 16 approximate the second end 20 and is adapted to engage the concrete form 12 about a slot, protrusion or brace 24 thereof. The engagement member 22 is engaged with the concrete form so that the handle 16 is positioned parallel to the surface 26 of the concrete structure 14 from which the form 12 is to be removed from.

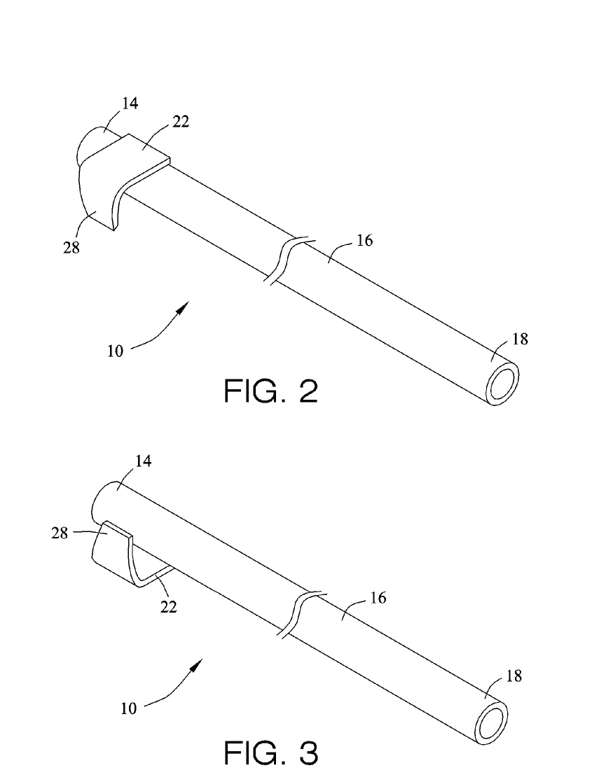

With reference to FIGS. 2a and 2b, the form engagement member 22 is affixed to the handle 16 approximate the second end and extends transversely therefrom. The form engagement member 22 includes a hooked end 28, which is adapted to engage with the concrete form 12 during removal thereof from the concrete structure 14. The hooked end 28 can be tapered to help facilitate engagement of the tool 10 with the form 12. For example, if the brace 24 became damaged and bent inward, the taper of the hooked end 28 will allow a user to more easily wedge the hooked end between the brace and the form.

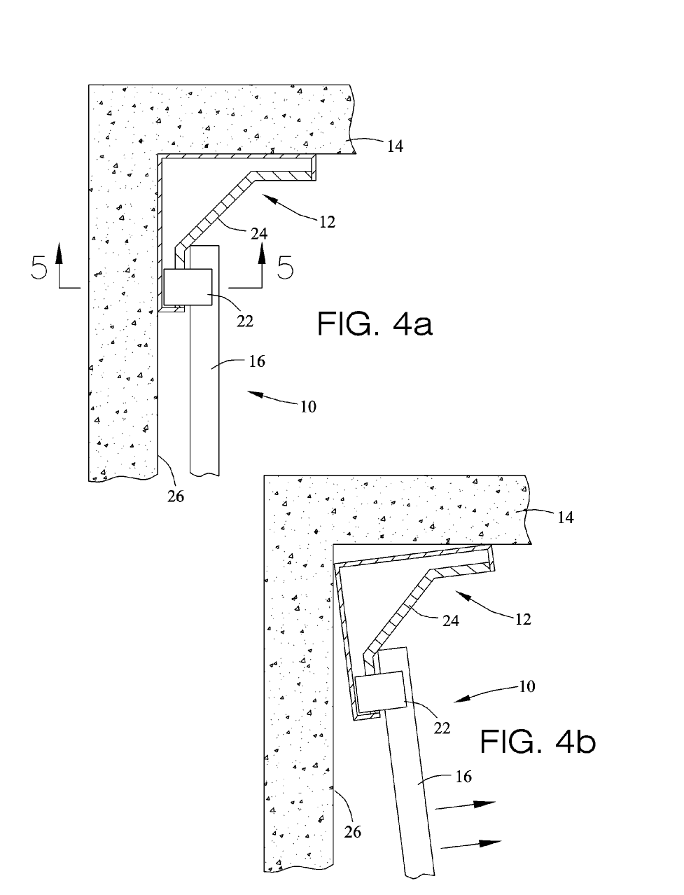

With reference to FIG. 4a, the concrete form removal tool 10 is illustrated in an initial position and engaged with the form 12 by the form engagement member 22. As illustrated, the initial position of the form removal tool 10 is such that the handle 16 is parallel to the surface 26, and such that the handle and the engagement member are not in contact with the surface or any part of concrete structure 14.

Now with reference to FIG. 4b, the concrete form removal tool 10 is illustrated in a pulled position in a direction away from the surface 26. In this position, the concrete form 12 has begun to be pulled free from the concrete structure 14. Additionally, the tool 10 remains free from contact with the concrete structure, thereby minimizing damage thereto by the tool during the operation of removing the form from the structure.

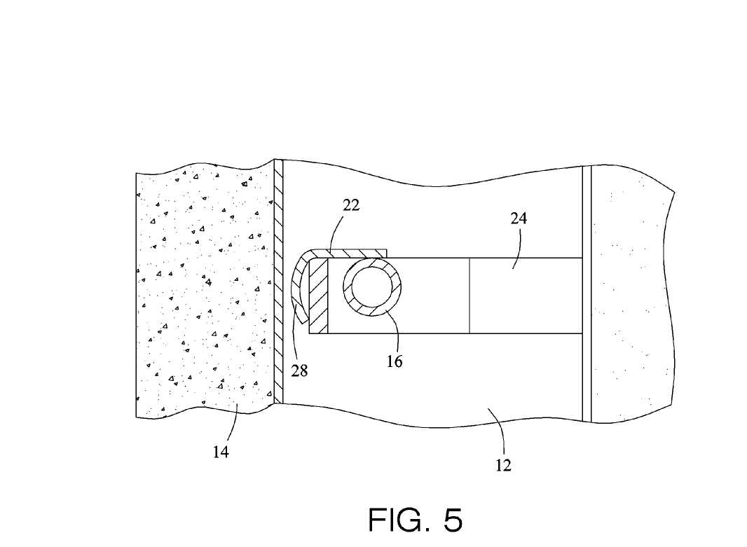

Turning now to FIG. 5, the hooked end 28 can be curved so that when the tool 10 is operated to pull the form 12 from the structure 14, the hooked end digs into the form and prevents the tool for becoming accidentally disengaged from the form and damaging the structure or injuring the user.

Turning back to FIG. 1, the handle 16 is of a length that is sufficient for a single user to pull upon approximate the first end and create a force large enough to break the form 12 free from structure 14. Preferably, the handle 16 is straight and free of bends.

A number of embodiments of the present invention have been described. Nevertheless, it will be understood that various modifications may be made without departing from the spirit and scope of the invention. Accordingly, other embodiments are within the scope of the following claims.

What is claimed is:

1. A concrete form pulling tool for prying a concrete form from a concrete structure, comprising:
an elongated handle having a first and a second end; and
a form engagement member affixed to said handle and extending transversely therefrom; and
said form engagement member having a hooked end that is adapted to engage said form so that said handle is initially positioned parallel to said concrete structure from which said form is to be pulled from and so that when said handle is pulled upon in a direction normal to said concrete structure said form is pulled therefrom.

2. The form pulling tool of claim 1, wherein said form engagement member is affixed to said handle approximate said second end.

3. The form pulling tool of claim 2, wherein said handle is of a length sufficient for a person to pull upon said first end and create a large enough moment force to pull said form from said structure.

4. The form pulling tool of claim 2, wherein said handle is straight.

5. The form pulling tool of claim 1, wherein said handle and said form engagement member is free of contact with said structure before and during removal of said form therefrom.

6. The form pulling tool of claim 1, wherein said hooked end is tapered.

7. A concrete form removing tool for pulling free a concrete form from a concrete structure, comprising:
a tool handle having a first and a second end;
a form engagement member affixed to said handle approximate said second end and extending transversely therefrom;
said form engagement member having a hooked end that is adapted for engagement with said form so that said handle is initially positioned parallel to said concrete structure from which said form is to be pulled from and so that when said handle is pulled upon in a direction normal to said concrete structure said form is pulled therefrom; and
wherein said handle and said form engagement member is free from contact with said concrete structure during operation of said tool.

8. The concrete form removing tool of claim 7, wherein said handle is substantially straight.

9. The concrete form removing tool of claim 8, wherein said handle is of a length sufficient for a person to pull upon said first end and create a large enough moment force to pull said form from said structure.

10. The concrete form removing tool of claim 9, wherein said hooked end is tapered.
